(19) United States
(12) Patent Application Publication
(10) Pub. No.: US 2025/0260458 A1
(43) Pub. Date: Aug. 14, 2025

(54) METHOD AND APPARATUS FOR MODEL MANAGEMENT AND COMMUNICATION SYSTEM

(71) Applicant: FUJITSU LIMITED, Kawasaki-sh (JP)

(72) Inventors: Qun ZHANG, Beijing (CN); Xin WANG, Beijing (CN); Gang SUN, Beijing (CN); Lei ZHANG, Beijing (CN)

(73) Assignee: FUJITSU LIMITED, Kawasaki-shi (JP)

(21) Appl. No.: 19/194,758

(22) Filed: Apr. 30, 2025

Related U.S. Application Data
(63) Continuation of application No. PCT/CN2022/130017, filed on Nov. 4, 2022.

(51) Int. Cl. H04B 7/06; H04L 41/16

(52) U.S. Cl. CPC H04B 7/0626; H04L 41/16

(57) ABSTRACT

An apparatus for model management, applicable to a terminal equipment, includes: a first receiver configured to receive information on a configuration and/or a scenario transmitted by a network device; and managing processor circuitry configured to manage a model used by the terminal equipment according to the configuration and/or the scenario.

### CROSS-REFERENCE TO RELATED APPLICATION

This application is a continuation application under 35 U.S.C. 111 (a) of International Patent Application PCT/CN2022/130017 filed on Nov. 4, 2022, and designated the U.S., the entire contents of which are incorporated herein by reference.

### TECHNICAL FIELD

This disclosure relates to the field of communication technologies.

### BACKGROUND

The multiple-input multiple-output (MIMO) technology is one of key technologies for 5G mobile communications. MIMO is able to provide higher channel capacities, but realization of the benefits is dependent on whether accurate channel state information is able to be acquired. In the MIMO technology, a terminal equipment measures spatial channels and feeds back channel state information (CSI) to a network device. The network device may select a precoding matrix appropriate for downlink transmission of the terminal equipment according to the channel state information reported by the terminal equipment, thereby minimizing a probability of error in receiving bits by the terminal equipment as much as possible.

A process for generating and feeding back channel state information may be summarized as follows. The network device transmits channel state information reference signals (CSI-RSs) to terminal equipment, and the terminal equipment estimate channels through the received CSI-RSs to obtain estimation of spatial channel matrices. The terminal equipment further acquires CSI by utilizing the estimated spatial channels. In the New Radio (NR) technology, a mode for feeding back the CSI is implicit feedback, that is, the terminal equipment feedback the CSI by recommending transmission parameters to the network device, wherein the transmission parameters include a channel state indicator (CQI), a precoding matrix indicator (PMI), a CSI-RS resource indicator (CRI), a synchronization signal block resource indicator (SSBRI), a layer indicator (LI), a rank indicator (RI) and physical layer RSRP (L1-RSRP). A base station may perform downlink transmission by directly using the parameters recommended by the terminal equipment, or it may not use the recommended parameters.

In a frequency division duplex (FDD) system, for a downlink, when a network device performs precoding by using information of a downlink channel, a terminal equipment is needed to feedback downlink channel state information to the network device via an uplink. However, as the information of the downlink channel is directly proportional to the number of antennas of the network device, in s scenario of massive MIMO, a huge number of antennas of the network device leads to a very large amount of feedback of channel state information of the downlink channel. The Third Generation Partnership Project (3GPP) has designed enhanced codebooks (such as Type II codebook) for downlink feedback, in which the amount of feedback of the channel state information is reduced through frequency domain compression. However, for valuable uplink resources, there is still a need to further reduce an amount of uplink feedback.

With the development of artificial intelligence/machine learning (AI/ML) technologies, applying the artificial intelligence/machine learning technologies to physical layers of wireless communication to solve difficulties of related methods has become a current technological direction. AI/ML models are applied to wireless communication systems, especially to new techniques with air-interface transmissions at 5G-Advanced and 6G phases.

FIG. 1 is a schematic diagram of performing CSI feedback based on AI/ML. As shown in FIG. 1, in operation 101, a terminal equipment side performs compression on downlink CSI by using an AI/ML-based CSI generation module to obtain compressed CSI, and a network device receives the compressed CSI via an air interface; and in operation 102, the network device performs decompression on the received CSI by using an AI/ML-based CSI reconstruction module to obtain recovered CSI. As what is transmitted in the air interface transmission is compressed channel state information, in cases where channel coefficient correlations are relatively good, an amount of feedback of uplink channels may be significantly reduced.

Furthermore, the AI/ML model technology is applied to beam management or positioning. For example, for the beam management, when the AI/ML model is used, spatially optimal beam pairs may be predicted according to measurement results of a few beams, and payload and latency of the system may be reduced.

It should be noted that the above description of the background art is merely provided for clear and complete explanation of this disclosure and for easy understanding by those skilled in the art. And it should not be understood that the above technical solution is known to those skilled in the art as it is described in the background art of this disclosure.

### SUMMARY

It was found by the inventors that as an AI/ML model is obtained by training at least one scenario and/or at least one configuration, the trained AI/ML model is not necessarily applicable to all scenarios and/or configurations. Therefore, there is a need to manage the AI/ML model, such as lifecycle management. However, in existing techniques, there is little discussion on lifecycle management for AI/ML models.

In order to solve at least one of the above problems or other similar problems, embodiments of this disclosure provide a method and an apparatus for model management and a communication system, in which a model is managed according to information on a configuration and/or a scenario. Hence, the model may be maintained in a state adapted to the configuration and/or the scenario, thereby improving reliability of the model.

According to one aspect of the embodiments of this disclosure, there is provided an apparatus for model management, applicable to a terminal equipment, the apparatus including:
a first receiving unit configured to receive information on a configuration and/or a scenario transmitted by a network device; and
a managing unit configured to manage a model used by the terminal equipment according to the configuration and/or the scenario.

According to another aspect of the embodiments of this disclosure, there is provided an apparatus of model management, applicable to a network device, the apparatus including:
a first transmitting unit configured to transmit information on a configuration and/or a scenario to a terminal equipment; and
a second receiving unit configured to receive information on managing a model used by the terminal equipment according to the configuration and/or the scenario by the terminal equipment.

An advantage of the embodiments of this disclosure exists in that a model is managed according to information on a configuration and/or a scenario. Hence, the model may be maintained in a state adapted to the configuration and/or the scenario, thereby improving reliability of the model.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

FIG. 1 is schematic diagram of performing CSI feedback based on AI/ML;

FIG. 2 is a schematic diagram of a communication system of this disclosure;

FIG. 3 is a schematic diagram of a method for model management of embodiments of a first aspect of this disclosure;

FIG. 4 is a schematic diagram of an example of managing a model used by a terminal equipment;

FIG. 5 is a schematic diagram of performing communications by the terminal equipment and a network device in a case where the model is adapted to a configuration and/or a scenario;

FIG. 6 is a schematic diagram of performing communications by the terminal equipment and the network device in the case where the terminal equipment is able to acquire the model adapted to the configuration and/or the scenario;

FIG. 7 is a schematic diagram of that the terminal equipment is able to acquire performing communications by the terminal equipment and the network device in the case where the model is adapted to the configuration and/or the scenario;

FIG. 8 is a schematic diagram of a method for model management of embodiments of a second aspect of this disclosure;

FIG. 9 is a schematic diagram of an apparatus for model management of embodiments of a third aspect of this disclosure;

FIG. 10 is a schematic diagram of an apparatus for model management of embodiments of a fourth aspect of this disclosure;

FIG. 11 is a schematic diagram of a terminal equipment of embodiments of a fifth aspect of this disclosure; and

FIG. 12 is a schematic diagram of a network device of the embodiments of the fifth aspect of this disclosure.

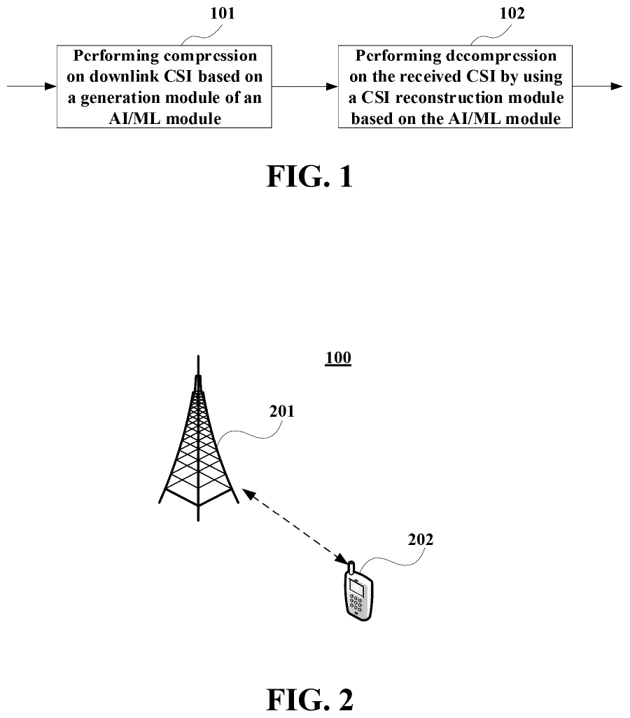

### DETAILED DESCRIPTION OF THE DISCLOSURE

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the spirit and terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, 5G, new radio (NR), and 6G in the future, etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following devices: an integrated access and feedback node (IAB-node), a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, depending on a context of the term.

In the embodiments of this disclosure, the term “user equipment (UE)” or “terminal equipment (TE) or terminal device” refers to, for example, an equipment accessing to a communication network and receiving network services via a network device. The user equipment may be fixed or mobile, and may also be referred to as a mobile station (MS), a terminal, a subscriber station (SS), an access terminal (AT), or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the terminal equipment may also be a machine or a device performing monitoring or measurement. For example, it may include but not limited to a machine-type communication (MTC) terminal, a vehicle mounted communication terminal, an industrial wireless device, a surveillance camera, a device to device (D2D) terminal, and a machine to machine (M2M) terminal, etc.

Moreover, the term “network side” or “network device side” refers to a side of a network, which may be a base station or one or more network devices including those described above. The term “user side” or “terminal side” or “terminal equipment side” refers to a side of a user or a terminal, which may be a UE, and may include one or more terminal equipments described above.

In the following description, without causing confusion, the terms “uplink control signal” and “uplink control information (UCI)” or “physical uplink control channel (PUCCH)” are replaced mutually, and terms “uplink data signal” and “uplink data information” or “physical uplink shared channel (PUSCH)” are replaced mutually.

The terms “downlink control signal” and “downlink control information (DCI)” or “physical downlink control channel (PDCCH)” are replaced mutually, and the terms “downlink data signal” and “downlink data information” or “physical downlink shared channel (PDSCH)” are replaced mutually.

In addition, transmitting or receiving a PUSCH may be understood as transmitting or receiving uplink data carried by the PUSCH, transmitting or receiving a PUCCH may be understood as transmitting or receiving uplink information carried by the PUCCH, transmitting or receiving a PRACH may be understood as transmitting or receiving a preamble carried by the PRACH. The uplink signal may include an uplink data signal and/or an uplink control signal, etc., and may be referred to as uplink transmission or uplink information or an uplink channel. Transmitting uplink transmission on an uplink resource may be understood as transmitting the uplink transmission by using uplink resource, the Likewise, downlink data/signal/channel/information may be understood correspondingly.

In the embodiments of this disclosure, higher-layer signaling may be, for example, radio resource control (RRC) signaling; for example, it is referred to an RRC message, which includes an MIB, system information, and a dedicated RRC message; or, it is referred to an as an RRC information element (RRC IE). Higher-layer signaling may also be, for example, medium access control (MAC) signaling, or an MAC control element (MAC CE); however, this disclosure is not limited thereto.

Scenarios in the embodiments of this disclosure shall be described below by way of examples; however, this disclosure is not limited thereto.

FIG. 2 is a schematic diagram of a communication system of this disclosure, in which a case where a terminal equipment and a network device are taken as examples is schematically shown. As shown in FIG. 2, a communication system 100 may include a network device 201 and a terminal equipment 202 (for the sake of simplicity, an example having only one terminal equipment is schematically given in FIG. 2).

In the embodiments of this disclosure, existing traffics or traffics that may be implemented in the future may be performed between the network device 201 and the terminal equipment 202. For example, such traffics may include but not limited to enhanced mobile broadband (eMBB), massive machine type communication (MTC), and ultra-reliable and low-latency communication (URLLC), etc.

The terminal equipment 202 may transmit data to the network device 201, such as in a grant or grant-free manner. The network device 201 may receive data transmitted by one or more terminal equipment 202, and feedback information to the terminal equipment 202, such as acknowledgement (ACK)/non-acknowledgement (NACK) information, and the terminal equipment 202 may acknowledge to terminate a transmission process, or may perform transmission of new data, or may perform data retransmission.

In the following description of this disclosure, an artificial intelligence (AI) model may also be referred to as an artificial intelligence/machine learning (AI/ML) model, that is, the AI model and the AI/ML model in this disclosure have the same meaning.

### Embodiments of a First Aspect

The embodiments of the first aspect provide a method for model management, applicable to a terminal equipment, such as the terminal equipment 202 in FIG. 2.

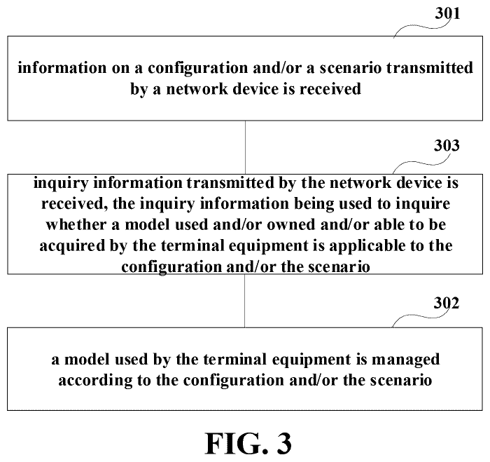

FIG. 3 is a schematic diagram of the method for model management of the embodiments of the first aspect of this disclosure. As shown in FIG. 3, the method includes:
operation 301: information on a configuration and/or a scenario transmitted by a network device is received; and
operation 302: a model used by the terminal equipment is managed according to the configuration and/or the scenario.

With the embodiments of the first aspect, the model is managed according to the information on a configuration and/or a scenario. Hence, the model may be maintained in a state adapted to the configuration and/or the scenario, thereby improving reliability of the model. For example, in a case where the configuration and/or the scenario is changed, the model may still be managed, so that the model is adapted to the changed configuration and/or scenario.

In at least one embodiment, the model in operation 302 is used to generate channel state information (CSI), and/or beam management, and/or positioning. The model may be an artificial intelligence (AI) model. The model is able to be adapted to at least one configuration and/or at least one scenario. For example, the model is trained based on at least one configuration and/or at least one scenario.

In at least one embodiment, the terminal equipment may have at least one model, for example, at least one model is stored in the terminal equipment. In addition, the terminal equipment may also obtain at least one model from other devices. For example, the terminal equipment may obtain at least one model from the network device side based on a model transfer mechanism, or the terminal equipment download the model via a public server or a server with an intellectual property.

In at least one embodiment, the configuration in operations 301 and 302 may be configurations specified in a communication protocol or configurations not specified in the communication protocol. Regarding the configurations that are not specified in the communication protocol, they may be, for example, antenna configurations of a network device.

In a specific example, the antenna configurations are used to configure at least one of the following parameters of an antenna of the network device:
the number of antenna panels included in a column of an antenna array;
the number of antenna panels included in a row of an antenna array;
a distance between antenna panels neighboring in a horizontal direction;
a distance between antenna panels neighboring in a vertical direction;
the antenna array being a uniform antenna array or a non-uniform antenna array; or
in an antenna panel, the number of antenna elements contained in a column, and/or the number of antenna elements contained in a row, and/or a distance between antennas neighboring in a horizontal direction, and/or a distance between antennas neighboring in a vertical direction, and/or an antenna in the antenna panel being of single polarization or dual polarization, and/or a tilt angle/tilt angles of a dual-polarized antenna/dual-polarized antennas (for example, a tilt angle of the antenna is 0°, or ±45°), etc.

In at least one embodiment, the number of the antenna configurations is one or more.

In one example, when there are more than one antenna configurations, the more than one antenna configurations may have corresponding antenna configuration identification numbers (IDs).

For example, the antenna configuration IDs may be first-level IDs, or may be second-level IDs. For the case of the second-level IDs, an example is as follows:
the second-level IDs of the antenna configurations may be denoted by an array ((α₁, α₂)), where, α₁ denotes a sub-ID of items of the antenna configurations, including “the number of antenna panels contained in a column of the antenna array” described above, etc. For example, a total number of the above antenna configurations may be 12, and a range of values of α₁ may be 1, 2, 3, . . . , 12. α₂ denotes a sub-ID of optional values in each antenna configuration item, for example, for the item “the number of antenna panels contained in a column of the antenna array”, there may be 6 options, and a range of values of α₂ may be 1, 2, 3, . . . , 6. At this point, (α₁, α₂) have total 72 possibilities, including (1,1), . . . , (12,6). For the above example, if it is the case of first-level IDs, the 72 possibilities of the first-level IDs of the antenna configurations are 1, 2, . . . , 72. A rule of order of arranging the first-level IDs of the antenna configurations may be predetermined.

In another example, the parameters of the antenna configurations and corresponding values thereof are predefined, such as being defined in a standard document of a communication protocol. For example, a parameter name of higher layer may be defined for items of each antenna configuration in the standard document, and parameter names and corresponding values thereof shown in Table 1 may be defined in the standard document. Table 1 shows examples of definitions of the parameter names and corresponding values thereof of the antenna configurations.

TABLE 1

| Items of antenna | (Examples of) the parameter | |
|---|---|---|
| configurations | names of the higher layer | (Examples of) values |
| The number of antenna | AntennaPanelNumber_Horizontal | 1, 2, . . . |
| panels included in a column | | |
| of an antenna array | | |
| The number of antenna | AntennaPanelNumber_Vertical | 1, 2, 4, . . . |
| panels included in a row of | | |
| an antenna array | | |
| A distance between | AntennaPanelDistance_Horizontal | 16 λ, 32 λ, . . . , . . . (λ |
| antenna panels neighboring | | denotes a wavelength of a |
| in a horizontal direction; | | signal received (transmitted |
| | | by the antenna)) |
| A distance between | AntennaPanelDistance_Vertical | 16λ, 32λ, . . . , . . . (λ |
| antenna panels neighboring | | denotes a wavelength of a |
| in a vertical direction | | signal received (transmitted |
| | | by the antenna)) |
| The antenna array | AntennaPanel_Property | Uniform, Non-uniform |
| being a uniform antenna | | |
| array or a non-uniform | | |
| antenna array | | |
| In an antenna panel, the | AntennaElementNumber_Horizontal | 1, 2, . . . |
| number of antenna elements | | |
| contained in a column | | |
| In an antenna panel, the | AntennaElementNumber_Vertical | 1, 2, 4, 8, 16, 32, . . . |
| number of antenna elements | | |
| contained in a row | | |
| In an antenna panel, a | AntennaElementDistance_Horizontal | 0.5λ, 0.8λ, . . . (λ |
| distance between antennas | | denotes a wavelength of a |
| neighboring in a horizontal | | signal received (transmitted |
| direction | | by the antenna)) |
| In an antenna panel, a | AntennaElementDistance_Vertical | 0.5λ, 0.8λ, . . . (λ |
| distance between antennas | | denotes a wavelength of a |
| neighboring in a vertical | | signal received (transmitted |
| direction | | by the antenna)) |
| An antenna in the antenna | Antenna_Polarization | 1, 2. |
| panel being of single | | |
| polarization or dual | | |
| polarization | | |
| A tilt angle of an antenna | Antenna_Angle | 0°, ±45° |
| (in the dual-polarized case) | | |

The antenna configuration identification number (ID) shall be taken as an example in the following description of this disclosure.

As shown in FIG. 3, the method further includes:
operation 303: inquiry information transmitted by the network device is received, the inquiry information being used to inquire whether a model used and/or owned and/or able to be acquired by the terminal equipment is applicable to the configuration and/or the scenario.

In operation 303, the inquiry information includes the information on a configuration and/or a scenario in operation 301, hence, operation 303 and operation 301 may be combined into one operation; or, the inquiry information does not include the information on a configuration and/or a scenario in operation 301, hence, operation 303 and operation 301 are separate operations.

In operation 301 and operation 303, the information on a configuration and/or a scenario and/or the inquiry information may be received via a downlink channel. The downlink channel is, for example, a physical downlink control channel (PDCCH), or a physical downlink shared channel (PDSCH), etc.

In at least one embodiment, corresponding to operation 301, the network device may transmit the information on a configuration and/or a scenario to the terminal equipment in a case where a scenario and/or a configuration change(s). For example, the terminal equipment still communicates with the same network device, and the antenna configuration of the network device changes, for example, at least one antenna panel is disabled. However, this disclosure is not limited thereto, and the network device may transmit the information on a configuration and/or a scenario to the terminal equipment in other cases (such as being enabled).

In at least one embodiment, the managing a model used by the terminal equipment in operation 302 includes model generalization, and/or model switching, and/or model update, and/or model type switching (e.g. switching from an AI model to a non-AI model, or from a non-AI model to an AI model), etc.

In the case of model update, the terminal equipment may record a version identification number (ID) of the model. In addition, when the model has an ID, a version ID under the model ID may still be recorded, such as version 3 of AI model 2.

In some implementations, the terminal equipment may report a result of the model management, or identification information (ID) corresponding to the result of the model management, i.e. a model management result ID, to the network device. The model management result ID may include several types of model management, such as within a generalization ability of the model, that is, the AI/ML model is adapted to the configuration and/or the scenario; model switching, model update. There are corresponding modes for processing each type of model management. For example, for the model update, modes for processing may include model trimming and model training. The model management result ID may be designed as a first-level ID, or a second-level level ID, or a third-level ID, etc. According to the above contents; however, it is not limited thereto. For a case of second-level IDs, a second-level ID may be defined as (a, b), where, a denotes a type of the model management, and b denotes a mode of processing under each type of model management. For a case of a three-level ID, a second-level ID may be defined as (a, b, c); where, a denotes a type of the model management, b denotes a mode of processing under each type of model management, and c denotes a version number of the model for the case of model update. A specific example is given in Table 2 below. It is assumed here that a total number of AI/ML models owned and able to be obtained by the terminal equipment is 6.

TABLE 2

| | | Binary | | Binary | | Binary |
|---|---|---|---|---|---|---|
| | | representation | | representation | | representation |
| | First- | of the first- | Second- | of the second- | Third- | of the third- |
| | level ID of | level ID of | level ID of | level ID of | level ID of | level ID of |
| | the result | the result | the result | the result | the result | the result |
| Results of the | of the model | of the model | of the model | of the model | of the model | of the model |
| model management | management | management | management | management | management | management |
| The AI model is | 1 | 0000 | (1, 1) | 00 000 | (1, 1, 1) | 00 000 00 |
| adapted to the | | | | | | |
| configuration | | | | | | |
| and/or the | | | | | | |
| scenario (without | | | | | | |
| being changed) | | | | | | |
| Model switching, | 2 | 0001 | (2, 1) | 01 000 | (2, 1, 1) | 01 000 00 |
| being switched to | | | | | | |
| model 1 | | | | | | |
| Model switching, | 3 | 0010 | (2, 2) | 01 001 | (2, 2, 1) | 01 001 00 |
| being switched to | | | | | | |
| model 2 | | | | | | |
| Model switching, | 4 | 0011 | (2, 3) | 01 010 | (2, 3, 1) | 01 010 00 |
| being switched to | | | | | | |
| model 3 | | | | | | |
| Model switching, | 5 | 0100 | (2, 4) | 01 011 | (2, 4, 1) | 01 011 00 |
| being switched to | | | | | | |
| model 4 | | | | | | |
| Model switching, | 6 | 0101 | (2, 5) | 01 100 | (2, 5, 1) | 01 100 00 |
| being switched to | | | | | | |
| model 5 | | | | | | |
| Model switching, | 7 | 0110 | (2, 6) | 01 101 | (2, 6, 1) | 01 101 00 |
| being switched to | | | | | | |
| model 6 | | | | | | |
| Model update: | 8 | 0111 | (3, 1) | 10 000 | (3, 1, 1) | 10 000 00 |
| model trimming, | | | | | | |
| model version | | | | | | |
| number 1 | | | | | | |
| Model update: | 9 | 1000 | (3, 2) | 10 001 | (3, 1, 2) | 10 000 01 |
| model trimming, | | | | | | |
| model version | | | | | | |
| number 2 | | | | | | |
| Model update: | 10 | 1001 | (3, 3) | 10 010 | (3, 1, 3) | 10 000 10 |
| model trimming, | | | | | | |
| model version | | | | | | |
| number 3 | | | | | | |
| Model update: | 11 | 1010 | (3, 4) | 10 011 | (3, 2, 1) | 10 001 00 |
| model training, | | | | | | |
| model version | | | | | | |
| number 1 | | | | | | |
| Model update: | 12 | 1011 | (3, 5) | 10 100 | (3, 2, 2) | 10 001 01 |
| model training, | | | | | | |
| model version | | | | | | |
| number 2 | | | | | | |
| Model update: | 13 | 1100 | (3, 6) | 10 101 | (3, 2, 3) | 10 001 10 |
| model training, | | | | | | |
| model version | | | | | | |
| number 3 | | | | | | |

It can be seen from Table 2 that an advantage of the first-level ID is that the number of bits needed in describing this ID may be saved, an advantage of the second-level ID is that a type of the model management may be clearly seen, and the third-level ID may record the version number of the model. In some implementations, for the model update only, the third-level ID may be introduced on the basis of the second-level ID, while the second-level ID is still used for the cases of the AI model being adapted to the configuration and/or the scenario and the model switching.

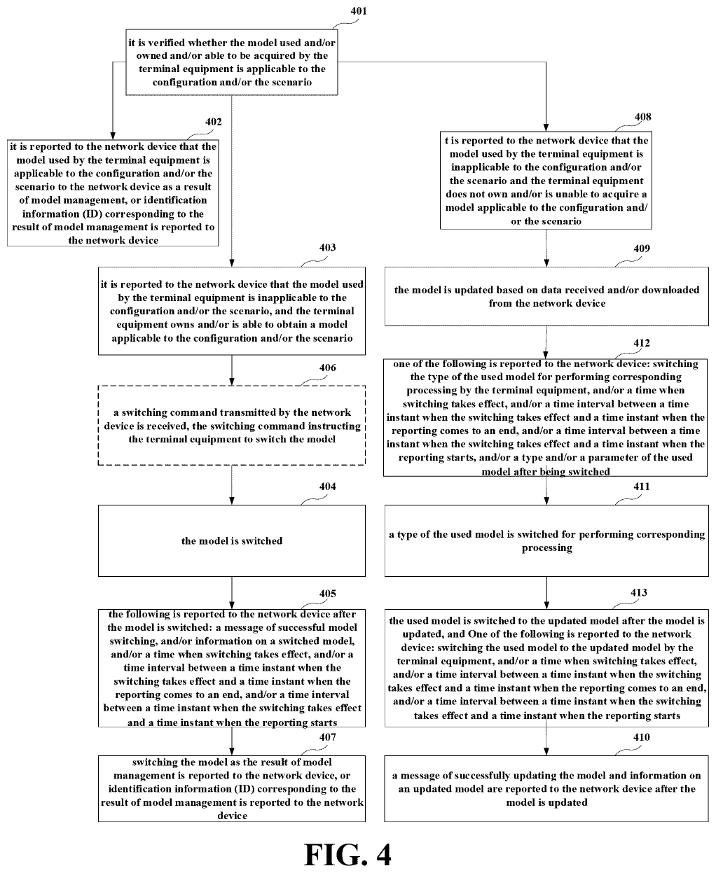

FIG. 4 is a schematic diagram of an example of managing the model used by the terminal equipment, which is used for implementation of operation 302. In this example, the antenna configuration of the network device is changed, for example, at least one antenna panel is disabled.

As shown in FIG. 4, the managing a model used by the terminal equipment includes:
operation 401: it is verified whether the model used and/or owned and/or able to be acquired by the terminal equipment is applicable to the configuration and/or the scenario; and
operation 402: it is reported to the network device that the model used by the terminal equipment is applicable to the configuration and/or the scenario to the network device as a result of model management, or identification information (ID) corresponding to the result of model management is reported to the network device.

In operation 401, a verification method may be viewing a manual of the AI/ML model, so as to see if the changed antenna configuration is included in the manual of the used AI/ML model, for example, the manual of the used AI/ML model records that it may be applicable to a case where some antenna panels are disabled.

Another verification method may be based on an AI/ML model monitoring method. For example, the terminal equipment requests the network device for antenna configuration data adapted to the change via an uplink channel, the data being pre-agreed upon by both parties, that is, data known to both parties. After receiving the request from the terminal equipment, the network device transmits data to the terminal equipment via a downlink channel. The terminal equipment receives the data, decodes the data, and calculates a block error rate (BLER). If the BLER is not greater than a value agreed upon by both parties in advance, it indicates that the AI/ML model being used by the terminal equipment is adapted to the changed antenna configuration; otherwise, it is not adapted thereto.

In operation 402, the terminal equipment may report to the network device via an uplink channel (a PUCCH or a PUSCH) that the AI/ML model being used by the terminal equipment may be adapted to the antenna configuration configured by the network device (e.g. the changed antenna configuration). For example, the generalization ability of the AI/ML model being used by the terminal equipment includes the antenna configuration configured by the network device, that is, the AI/ML model may be applicable to multiple configurations and/or scenarios. For the case of reporting by using the first-level ID of the model management result ID, in the example in Table 2, the reported ID is 1, which may be described by using a bit sequence “0000”. And for the case of reporting by using the second-level ID of the model management result ID, in the example in Table 2, the reported ID is (1,1), which may be described by using a bit sequence “00 000”.

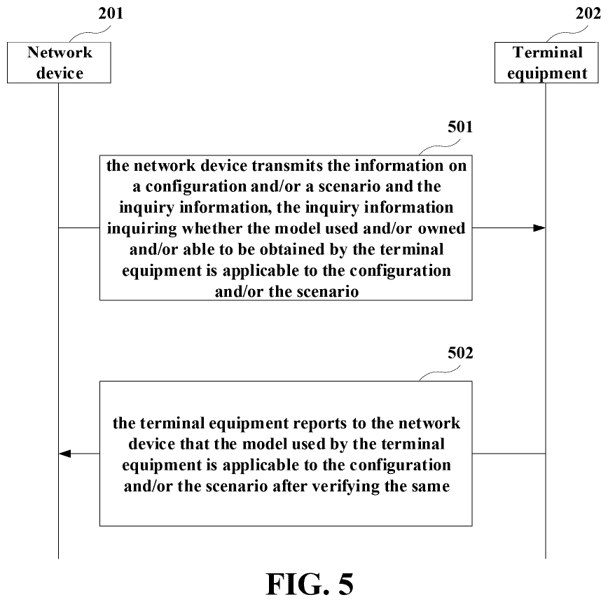

FIG. 5 is a schematic diagram of performing communications by the terminal equipment and the network device in a case where the model is adapted to the configuration and/or the scenario. FIG. 5 corresponds to the case of operation 402.

As shown in FIG. 5:
operation 501: the network device transmits the information on a configuration and/or a scenario and the inquiry information, the inquiry information inquiring whether the model used and/or owned and/or able to be obtained by the terminal equipment is applicable to the configuration and/or the scenario; and
operation 502: the terminal equipment reports to the network device that the model used by the terminal equipment is applicable to the configuration and/or the scenario after verifying the same.

As shown in FIG. 4, the managing the model used by the terminal equipment may further include:
operation 403: it is reported to the network device that the model used by the terminal equipment is inapplicable to the configuration and/or the scenario, and the terminal equipment owns and/or is able to obtain a model applicable to the configuration and/or the scenario.

As shown in FIG. 4, the managing the model used by the terminal equipment may further include:
operation 404: the model is switched; and
operation 405: the following is reported to the network device after the model is switched: a message of successful model switching, and/or information on a switched model, and/or a time when switching takes effect, and/or a time interval between a time instant when the switching takes effect and a time instant when the reporting comes to an end, and/or a time interval between a time instant when the switching takes effect and a time instant when the reporting starts.

In operation 405, the information on the switched model corresponds to the configuration and/or the scenario.

In at least one embodiment, the switching the model in operation 404 may be performed spontaneously by the terminal equipment, or may be performed based on an instruction of the network device. For example, as shown in FIG. 4, the managing the model used by the terminal equipment further includes:

operation 406: a switching command transmitted by the network device is received, the switching command instructing the terminal equipment to switch the model.

With operation 406, the terminal equipment may perform model switching upon receiving the switching command from the network device.

As shown in FIG. 4, the managing the model used by the terminal equipment may further include:
operation 407: switching the model as the result of model management is reported to the network device, or identification information (ID) corresponding to the result of model management is reported to the network device.

In a specific example, explanations of operations 403-407 are as follows.

The terminal equipment reports to the network device via an uplink channel (a PUCCH or a PUSCH), and a reported content includes that the AI/ML model being used by the terminal equipment is not adapted to the changed antenna configuration configured by the network device. The terminal equipment repeats the above verification process on the AI/ML models it owns or is able to acquire to test whether the AI/ML model it owns or is able to acquire is adapted to the changed antenna configuration. The AI/ML model that is able to be acquired may be an AI/ML model transmitted by the network device to the terminal equipment, or an AI/ML model downloaded by the terminal equipment via a public server or a server with intellectual property. The terminal equipment reports to the network device via an uplink channel (a PUCCH or a PUSCH), and a reported content includes that the terminal equipment owns or is able to acquire the AI/ML model of the changed antenna configuration applicable to the network device. The network device transmits a signal via a downlink channel to notify the terminal equipment to switch the AI/ML model. After receiving the signaling, the terminal equipment switches to an appropriate AI/ML model and reports to the network device via an uplink channel, and a reported content includes that the terminal equipment successfully switches the AI/ML model, and information on the switched AI/ML model, such as a model ID. For a case where the network device side has an AI/ML model monitoring function, the network device processes a KPI monitored by the AI/ML model after receiving the report from the terminal equipment. For example, if the KPI monitored by the AI/ML model is a BLER, the network device resets an error counter to be 0, and then perform AI/ML model monitoring.

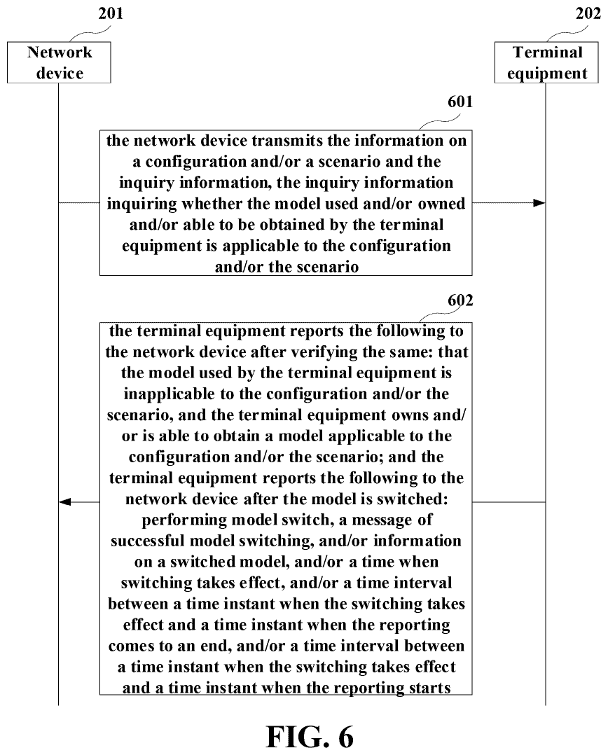

FIG. 6 is a schematic diagram of performing communications by the terminal equipment and the network device in the case where the terminal equipment is able to acquire the model adapted to the configuration and/or the scenario. Operation 602 in FIG. 6 corresponds to the cases in operations 403-407.

As shown in FIG. 6,
operation 601: the network device transmits the information on a configuration and/or a scenario and the inquiry information, the inquiry information inquiring whether the model used and/or owned and/or able to be obtained by the terminal equipment is applicable to the configuration and/or the scenario; and
operation 602: the terminal equipment reports the following to the network device after verifying the same: that the model used by the terminal equipment is inapplicable to the configuration and/or the scenario, and the terminal equipment owns and/or is able to obtain a model applicable to the configuration and/or the scenario; and the terminal equipment reports the following to the network device after the model is switched: performing model switch, a message of successful model switching, and/or information on a switched model, and/or a time when switching takes effect, and/or a time interval between a time instant when the switching takes effect and a time instant when the reporting comes to an end, and/or a time interval between a time instant when the switching takes effect and a time instant when the reporting starts.

As shown in FIG. 4, the managing the model used by the terminal equipment may further include:
operation 408: it is reported to the network device that the model used by the terminal equipment is inapplicable to the configuration and/or the scenario and the terminal equipment does not own and/or is unable to acquire a model applicable to the configuration and/or the scenario.

As shown in FIG. 4, the managing the model used by the terminal equipment may further include:
operation 409: the model is updated based on data received and/or downloaded from the network device; and
operation 410: a message of successfully updating the model and information on an updated model are reported to the network device after the model is updated.

In operation 409, the terminal equipment receives the data from the network device via signaling, or the terminal equipment receives the data from the network device in a form of data packet; wherein the signaling includes: radio resource control (RRC), media access control control element (MAC CE) signaling or downlink control information (DCI), etc. In addition, before operation 409, the terminal equipment may first transmit a message for requesting data to the network device, and then, in operation 409, it may receive the data from the network device.

In operation 409, the terminal equipment may also download the data from a public server or a server with intellectual property (IP).

The received data and/or the downloaded data include: original data and/or data obtained by quantifying the original data. For example, the data may be vectors of a spatial channel matrix, or may be quantized based on vectors of a spatial channel matrix. A quantization method includes single-precision floating-point numbers, double-precision floating-point numbers, integers, and any codebook specified in the Third Generation Partnership Project (3GPP), or may also be a combination of a structure of any codebook in 3GPP and a set of customized non-3GPP specified parameters.

In operation 409, the updating the model includes: trimming or training the used model. In addition, after the model update, the terminal equipment may record a version number of the updated model, such as a version number of the updated AI model.

In operation 410, the information on the updated model includes: identification information (ID) and/or model version information of the updated model.

As shown in FIG. 4, the managing the model used by the terminal equipment further includes:
operation 411: a type of the used model is switched for performing corresponding processing.

Operation 411 may also be referred to as model backoff. In operation 411, the switching a type of the used model includes: switching from an artificial intelligence model to a non-artificial intelligence model, or switching from a non-artificial intelligence model to an artificial intelligence model. For example, if a time needed in updating a model (such as an AI model) is greater than a threshold, the terminal equipment may switch an AI model being used to a non-AI model to proceed with corresponding processing, so as to avoid too long time of service suspension, wherein the corresponding processing includes: generating channel state information, and/or beam management, and/or positioning.

For example, in operation 411, the terminal equipment may select to back off from using an AI model for CSI feedback to using a traditional codebook method for CSI feedback, and the terminal equipment reports its backoff for the AI model, a time of the backoff and types of codebooks and recommended parameters specified in the traditional 3GPP to the network device via an uplink channel; wherein the types of codebooks include an Rel-15 single-panel type 1 codebook, an Rel-15 multi-panel type 1 codebook, an Rel-15 type 2 codebook, an Rel-15 type 2 port selection codebook, an Rel-16 type 2 codebook, an Rel-16 type 2 port selection codebook, and an Rel-17 type 2 codebook, etc.

As shown in FIG. 4, the managing the model used by the terminal equipment further includes:
operation 412: the following is reported to the network device before the type of the used model is switched (such as before operation 411): switching the type of the used model for performing corresponding processing by the terminal equipment, and/or a time when switching takes effect, and/or a time interval between a time instant when the switching takes effect and a time instant when the reporting comes to an end, and/or a time interval between a time instant when the switching takes effect and a time instant when the reporting starts, and/or a type and/or a parameter of the used model after being switched.

With operation 412, the network device may make preparation, so as to cooperate with the model backoff of the terminal equipment.

As shown in FIG. 4, the managing the model used by the terminal equipment further includes:
operation 413: the used model is switched to the updated model after the model is updated, and the following is reported to the network device: switching the used model to the updated model by the terminal equipment, and/or a time when switching takes effect, and/or a time interval between a time instant when the switching takes effect and a time instant when the reporting comes to an end, and/or a time interval between a time instant when the switching takes effect and a time instant when the reporting starts.

With operation 413, the backoff model in operation 411 may be switched to the updated model, such as switching from a non-AI model to an updated AI model. And with the reporting of the terminal equipment, the network device may make preparation, so as to cooperate with the model switching of the terminal equipment.

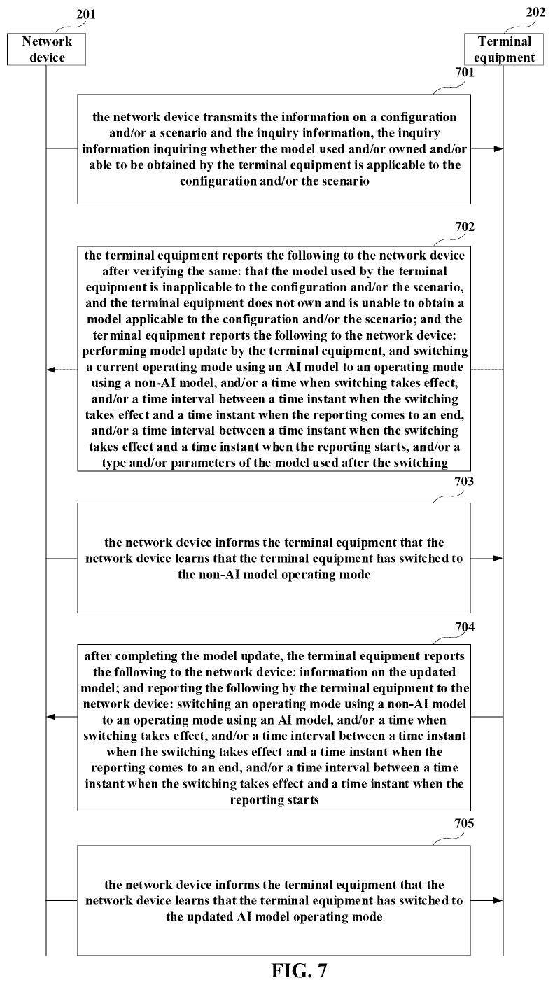

FIG. 7 is a schematic diagram of performing communications by the terminal equipment and the network device in the case where the terminal equipment is able to acquire the model adapted to the configuration and/or the scenario. Operations in FIG. 7 correspond to the cases in operations 408-413.

As shown in FIG. 7:
operation 701: the network device transmits the information on a configuration and/or a scenario and the inquiry information, the inquiry information inquiring whether the model used and/or owned and/or able to be obtained by the terminal equipment is applicable to the configuration and/or the scenario;
operation 702: the terminal equipment reports the following to the network device after verifying the same: that the model used by the terminal equipment is inapplicable to the configuration and/or the scenario, and the terminal equipment does not own and is unable to obtain a model applicable to the configuration and/or the scenario; and the terminal equipment reports the following to the network device: performing model update by the terminal equipment, and switching a current operating mode using an AI model to an operating mode using a non-AI model, and/or a time when switching takes effect, and/or a time interval between a time instant when the switching takes effect and a time instant when the reporting comes to an end, and/or a time interval between a time instant when the switching takes effect and a time instant when the reporting starts, and/or a type and/or parameters of the model used after the switching;
operation 703: the network device informs the terminal equipment that the network device learns that the terminal equipment has switched to the non-AI model operating mode;
operation 704: after completing the model update, the terminal equipment reports the following to the network device: information on the updated model; and reporting the following by the terminal equipment to the network device: switching an operating mode using a non-AI model to an operating mode using an AI model, and/or a time when switching takes effect, and/or a time interval between a time instant when the switching takes effect and a time instant when the reporting comes to an end, and/or a time interval between a time instant when the switching takes effect and a time instant when the reporting starts; and
operation 705: the network device informs the terminal equipment that the network device learns that the terminal equipment has switched to the updated AI model operating mode.

In the above embodiments, the signaling transmitted via the downlink channel may be RRC signaling, or MAC CE signaling, or DCI signaling, and the signaling transmitted via the uplink channel may be RRC signaling, or MAC CE signaling, or UCI signaling.

In this disclosure, the higher-layer signaling may be, for example, radio resource control (RRC) signaling; for example, it is referred to an RRC message, which includes a master information block (MIB), system information, and a dedicated RRC message; or, it is referred to an as an RRC information element (RRC IE). The higher-layer signaling may also be, for example, medium access control (MAC) signaling, or an MAC control element (MAC CE); however, this disclosure is not limited thereto.

In the embodiments of this disclosure, one or more AI/ML models may be configured and run in the network device and/or the terminal equipment. The AI/ML model may be used for various signal processing functions in wireless communications, such as CSI estimation and reporting, beam management and beam prediction, and positioning, etc.; however, this disclosure is not limited thereto.

Embodiments of managing the model used by the terminal equipment based on scenarios shall be described below.

In at least some embodiments, the terminal equipment moves from a cell covered by the current network device to a cell covered by another network device, wherein an antenna configuration of the other network device is different from that of the network device (i.e. the current network device). A scenario of the cell covered by the other network device is different from the previous scenario of the cell where the terminal equipment is located.

For the scenario where “the terminal equipment moves to a cell covered by another network device”, the terminal equipment inquires the network device (i.e. the other network device) about a scenario where it is located and a configuration used thereby via an uplink channel. The terminal equipment may also possibly report information on the AI/ML model it is currently using to the network device, the information being a predefined model ID. The network device informs the terminal equipment of the scenario where it is located and the configuration used thereby via a downlink channel, and inquires the terminal equipment whether the AI/ML model currently used by it is adapted to the scenario and configuration informed by the network device, or whether the terminal equipment owns and/or is able to acquire an AI/ML model that is adapted to the scenario and configuration informed by the network device. The terminal equipment verifies whether the AI/ML model it is currently using is adapted to the scenario and configuration informed by the network device, or whether the terminal equipment owns and/or is able to acquire the AI/ML model adapted to the scenario and configuration informed by the network device, and a verification method may be that previously described. The terminal equipment may further use the methods and/or processes described above for model management, including not changing the model (i.e. within a generalization ability of the model), or performing model switching, or performing model update. In the model update, the AI/ML model may be backed off to a method specified in existing standards based on non-AI/ML methods for CSI generation and feedback, and/or beam management, and/or positioning. The terminal equipment completes actions to which the model management corresponds and reports a result of the model management to the network device, and a reporting method may be similar to the methods and/or processes described above.

### Embodiments of a Second Aspect

At least addressed to the problem identical to that in the embodiments of the first aspect, the embodiments of the second aspect provide a method for model management, which is applicable to a network device, and corresponds to the embodiments of the first aspect.

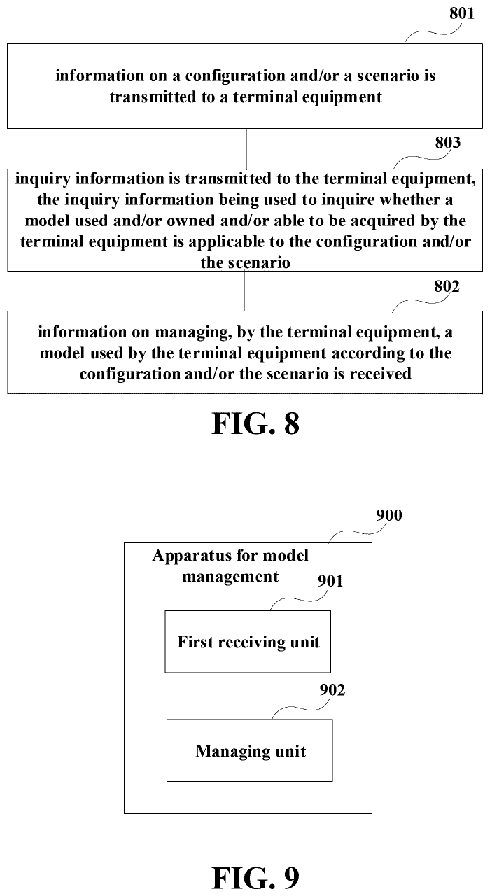

FIG. 8 is a schematic diagram of the method for model management of the embodiments of the second aspect of this disclosure. The method includes:
operation 801: information on a configuration and/or a scenario is transmitted to a terminal equipment; and
operation 802: information on managing, by the terminal equipment, a model used by the terminal equipment according to the configuration and/or the scenario is received.

In, operation 802, the model is used to generate channel state information (CSI), and/or beam management, and/or positioning. For example, the model is an artificial intelligence model, the terminal equipment owns and/or is able to acquire at least one of the models, and the model is applicable to at least one configuration and/or at least one scenario.

In at least one embodiment, the configuration includes an antenna configuration of the network device.

The antenna configuration is used to configure at least one of the following parameters of an antenna of the network device:
the number of antenna panels included in a column of an antenna array;
the number of antenna panels included in a row of an antenna array;
a distance between antenna panels neighboring in a horizontal direction;
a distance between antenna panels neighboring in a vertical direction;
the antenna array being a uniform antenna array or a non-uniform antenna array; or
in an antenna panel, the number of antenna elements contained in a column, and/or the number of antenna elements contained in a row, and/or a distance between antennas neighboring in a horizontal direction, and/or a distance between antennas neighboring in a vertical direction, and/or an antenna in the antenna panel being of single polarization or dual polarization, and/or a tilt angle/tilt angles of a dual-polarized antenna/dual-polarized antennas.

In at least one embodiment, the number of the antenna configuration is one or more, and more than one antenna configurations have corresponding antenna configuration identification numbers (IDs), or parameters of the antenna configurations and values corresponding to the antenna configurations are predefined.

In at least one embodiment, as shown in FIG. 8, the method further includes:
Operation 803: inquiry information is transmitted to the terminal equipment, the inquiry information being used to inquire whether a model used and/or owned and/or able to be acquired by the terminal equipment is applicable to the configuration and/or the scenario.

The inquiry information includes the information on a configuration and/or a scenario, or the inquiry information does not include the information on a configuration and/or a scenario.

In at least one embodiment, the information on managing the used model by the terminal equipment includes: a result of model management, or identification information (ID) corresponding to the result of model management, wherein the result of model management includes that the model used by the terminal equipment is applicable to the configuration and/or the scenario.

In at least one embodiment, the information on managing the used model by the terminal equipment includes:
that the model used by the terminal equipment is not applicable to the configuration and/or the scenario, and the terminal equipment owns and/or is able to acquire a model applicable to the configuration and/or the scenario.

Furthermore, the information on managing the used model by the terminal equipment includes:
a message of successful model switching, and/or information on a switched model, and/or a time when switching takes effect, and/or a time interval between a time instant when the switching takes effect and a time instant when the network device receives the information on managing the used model by the terminal equipment.

Furthermore, the information on managing the used model by the terminal equipment further includes:
a result of model management, or identification information (ID) corresponding to the result of model management,
wherein the result of model management includes: switching the model.

Furthermore, the network device may transmit a switching command to the terminal equipment, the switching command instructing the terminal equipment to switch the model.

In at least one other embodiment, the information on managing the used model by the terminal equipment further includes: that the model used by the terminal equipment is inapplicable to the configuration and/or the scenario, and the terminal equipment does not own and/or is unable to acquire a model applicable to the configuration and/or the scenario.

The information on managing the used model by the terminal equipment further includes:
a message of successfully updating the model and information on the updated model.

The updating the model includes: trimming or training the used model. The information on the updated model includes: identification information (ID) and/or model version information of the updated model.

The information on managing the used model by the terminal equipment further includes:
a result of model management, or identification information (ID) corresponding to the result of model management.

The result of model management includes: updating the model.

Furthermore, the network device transmits data for updating the model to the terminal equipment by the network device via signaling or in a form of data packet. The signaling includes: radio resource control (RRC), media access control control element (MAC CE) signaling or downlink control information (DCI).

The data include original data and/or data obtained by quantifying the original data.

Furthermore, the network device switches a type of the used model for performing corresponding processing.

The switching a type of the used model includes: switching from an artificial intelligence model to a non-artificial intelligence model, or switching from a non-artificial intelligence model to an artificial intelligence model. The corresponding processing includes: generating channel state information, and/or beam management, and/or positioning.

Furthermore, the information on managing the used model by the terminal equipment includes:
switching the type of the used model for performing corresponding processing by the terminal equipment, and/or a time when switching takes effect, and/or a time interval between a time instant when the switching takes effect and a time instant when the reporting comes to an end, and/or a time interval between a time instant when the switching takes effect and a time instant when the reporting starts, and/or a type and/or a parameter of the used model after being switched.

Furthermore, the information on managing the used model by the terminal equipment includes:
switching the used model to the updated model by the terminal equipment, and/or a time when switching takes effect, and/or a time interval between a time instant when the switching takes effect and a time instant when the network device receives the information on managing the used model by the terminal equipment.

Furthermore, the network device switches the used model to a model corresponding to the updated model.

### Embodiments of a Third Aspect

The embodiments of the third aspect provide an apparatus for model management, which is applicable to a terminal equipment, and corresponds to the method in the embodiments of the first aspect.

FIG. 9 is a schematic diagram of the apparatus for model management of the embodiments of the third aspect of this disclosure. As shown in FIG. 9, an apparatus 900 includes:
a first receiving unit 901 configured to receive information on a configuration and/or a scenario transmitted by a network device; and
a managing unit 902 configured to manage a model used by the terminal equipment according to the configuration and/or the scenario.

In at least one embodiment, the model is used to generate channel state information (CSI), and/or beam management, and/or positioning.

In at least one embodiment, the model is an artificial intelligence model, the terminal equipment owns and/or is able to acquire at least one of the models, and the model is applicable to at least one configuration and/or at least one scenario.

In at least one embodiment, the configuration includes an antenna configuration of the network device.

In at least one embodiment, the antenna configuration is used to configure at least one of the following parameters of an antenna of the network device:
the number of antenna panels included in a column of an antenna array;
the number of antenna panels includes in a row of an antenna array;
a distance between antenna panels neighboring in a horizontal direction;
a distance between antenna panels neighboring in a vertical direction;
the antenna array being a uniform antenna array or a non-uniform antenna array; or
in an antenna panel, the number of antenna elements contained in a column, and/or the number of antenna elements contained in a row, and/or a distance between antennas neighboring in a horizontal direction, and/or a distance between antennas neighboring in a vertical direction, and/or an antenna in the antenna panel being of single polarization or dual polarization, and/or a tilt angle/tilt angles of a dual-polarized antenna/dual-polarized antennas.

In at least one embodiment, the number of the antenna configuration is one or more, and more than one antenna configurations have corresponding antenna configuration identification numbers (IDs), or parameters of the antenna configurations and values corresponding to the antenna configurations are predefined.

In at least one embodiment, the first receiving unit is further configured to:
receive inquiry information transmitted by the network device, the inquiry information being used to inquire whether a model used and/or owned and/or able to be acquired by the terminal equipment is applicable to the configuration and/or the scenario.

In at least one embodiment, the inquiry information includes the information on a configuration and/or scenario, or the inquiry information does not include the information on a configuration and/or scenario.

In at least one embodiment, the managing a model used by the terminal equipment includes: verifying whether the model used and/or owned and/or able to be acquired by the terminal equipment is applicable to the configuration and/or the scenario; and reporting that the model used by the terminal equipment is applicable to the configuration and/or the scenario to the network device as a result of model management, or reporting identification information (ID) corresponding to the result of model management to the network device.

In at least one embodiment, the managing a model used by the terminal equipment includes:
verifying whether the model used and/or owned and/or able to be acquired by the terminal equipment is applicable to the configuration and/or the scenario; and
reporting to the network device that the model used by the terminal equipment is inapplicable to the configuration and/or the scenario and the terminal equipment owns and/or is able to acquire a model applicable to the configuration and/or the scenario.

In at least one embodiment, the managing a model used by the terminal equipment further includes:
switching the model; and
reporting the following to the network device after switching the model:
a message of successful model switching, and/or information on a switched model, and/or a time when switching takes effect, and/or a time interval between a time instant when the switching takes effect and a time instant when the reporting comes to an end, and/or a time interval between a time instant when the switching takes effect and a time instant when the reporting starts.

In at least one embodiment, the managing a model used by the terminal equipment further includes:
reporting switching the model to the network device as a result of model management, or reporting identification information (ID) corresponding to the result of model management to the network device.

In at least one embodiment, the managing a model used by the terminal equipment further includes:
receiving a switching command transmitted by the network device, the switching command instructing the terminal equipment to switch the model.

In at least one embodiment, information on the switched model corresponds to the configuration and/or the scenario.

In at least one embodiment, the managing a model used by the terminal equipment further includes:
verifying whether the model used and/or owned and/or able to be acquired by the terminal equipment is applicable to the configuration and/or the scenario; and
reporting to the network device that the model used by the terminal equipment is inapplicable to the configuration and/or the scenario and the terminal equipment does not own and/or is unable to acquire a model applicable to the configuration and/or the scenario.

In at least one embodiment, the managing a model used by the terminal equipment further includes:
updating the model based on data received and/or downloaded from the network device; and
reporting a message of successfully updating the model and information on an updated model to the network device after updating the model.

In at least one embodiment, the managing a model used by the terminal equipment further includes:
reporting updating the model to the network device as a result of model management, or reporting identification information (ID) corresponding to the result of model management to the network device.

In at least one embodiment, the terminal equipment receives the data from the network device via signaling, or the terminal equipment receives the data from the network device in a form of data packet, or
the terminal equipment downloads the data from a public server or a server with intellectual property (IP).

In at least one embodiment, the signaling includes: radio resource control (RRC), media access control control element (MAC CE) signaling or downlink control information (DCI).

In at least one embodiment, the updating the model includes: trimming or training the used model.

In at least one embodiment, the information on the updated model includes: identification information (ID) and/or model version information of the updated model.

In at least one embodiment, the received data and/or the downloaded data include original data and/or data obtained by quantifying the original data.

In at least one embodiment, the managing a model used by the terminal equipment further includes:
switching a type of the used model for performing corresponding processing.

In at least one embodiment, the switching a type of the used model includes: switching from an artificial intelligence model to a non-artificial intelligence model, or switching from a non-artificial intelligence model to an artificial intelligence model.

In at least one embodiment, the corresponding processing includes:
generating channel state information, and/or beam management, and/or positioning.

In at least one embodiment, the managing a model used by the terminal equipment further includes:
reporting the following to the network device before switching the type of the used model: switching the type of the used model for performing corresponding processing by the terminal equipment, and/or a time when switching takes effect, and/or a time interval between a time instant when the switching takes effect and a time instant when the reporting comes to an end, and/or a time interval between a time instant when the switching takes effect and a time instant when the reporting starts, and/or a type and/or a parameter of the used model after being switched.

In at least one embodiment, the managing a model used by the terminal equipment further includes:
switching the used model to the updated model after updating the model, and reporting the following to the network device:
switching the used model to the updated model by the terminal equipment, and/or a time when switching takes effect, and/or a time interval between a time instant when the switching takes effect and a time instant when the reporting comes to an end, and/or a time interval between a time instant when the switching takes effect and a time instant when the reporting starts.

### Embodiments of a Fourth Aspect

The embodiments of the fourth aspect provide an apparatus for model management, which is applicable to a network device, and corresponds to the method in the embodiments of the second aspect.

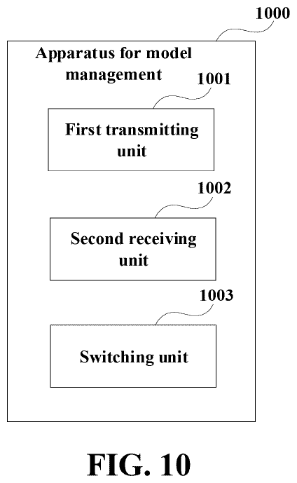

FIG. 10 is a schematic diagram of the apparatus for model management of the embodiments of the fourth aspect of this disclosure. As shown in FIG. 10, an apparatus 1000 includes:
a first transmitting unit 1001 configured to transmit information on a configuration and/or a scenario to a terminal equipment; and
a second receiving unit 1002 configured to receive information on managing a model used by the terminal equipment according to the configuration and/or the scenario by the terminal equipment.

In at least one embodiment, the model is used to generate channel state information (CSI), and/or beam management, and/or positioning.

In at least one embodiment, the model is an artificial intelligence model, the terminal equipment owns and/or is able to acquire at least one of the models, and the model is applicable to at least one configuration and/or at least one scenario.

In at least one embodiment, the configuration includes an antenna configuration of the network device.

In at least one embodiment, the antenna configuration is used to configure at least one of the following parameters of an antenna of the network device:
the number of antenna panels includes in a column of an antenna array;
the number of antenna panels includes in a row of an antenna array;
a distance between antenna panels neighboring in a horizontal direction;
a distance between antenna panels neighboring in a vertical direction;
the antenna array being a uniform antenna array or a non-uniform antenna array; or
in an antenna panel, the number of antenna elements contained in a column, and/or the number of antenna elements contained in a row, and/or a distance between antennas neighboring in a horizontal direction, and/or a distance between antennas neighboring in a vertical direction, and/or an antenna in the antenna panel being of single polarization or dual polarization, and/or a tilt angle/tilt angles of a dual-polarized antenna/dual-polarized antennas.

In at least one embodiment, the number of the antenna configuration is one or more, and more than one antenna configurations have corresponding antenna configuration identification numbers (IDs), or parameters of the antenna configurations and values corresponding to the antenna configurations are predefined.

In at least one embodiment, the first transmitting unit is further configured to:
transmit inquiry information to the terminal equipment, the inquiry information being used to inquire whether a model used and/or owned and/or able to be acquired by the terminal equipment is applicable to the configuration and/or the scenario.

In at least one embodiment, the inquiry information includes the information on a configuration and/or a scenario, or the inquiry information does not include the information on a configuration and/or a scenario.

In at least one embodiment, the information on managing the used model by the terminal equipment includes:
a result of model management, or identification information (ID) corresponding to the result of model management, wherein the result of model management includes that the model used by the terminal equipment is applicable to the configuration and/or the scenario.

In at least one embodiment, the information on managing the used model by the terminal equipment includes:
that the model used by the terminal equipment is inapplicable to the configuration and/or the scenario, and the terminal equipment owns and/or is able to acquire a model applicable to the configuration and/or the scenario.

In at least one embodiment, the information on managing the used model by the terminal equipment further includes:
a message of successful model switching, and/or information on a switched model, and/or a time when switching takes effect, and/or a time interval between a time instant when the switching takes effect and a time instant when the network device receives the information on managing the used model by the terminal equipment.

In at least one embodiment, the information on managing the used model by the terminal equipment further includes:
a result of model management, or identification information (ID) corresponding to the result of model management, wherein the result of model management includes: switching the model.

In at least one embodiment, the first transmitting unit is further configured to:
transmit a switching command to the terminal equipment, the switching command instructing the terminal equipment to switch the model.

In at least one other embodiment, the information on the switched model corresponds to the configuration and/or the scenario.

In at least one embodiment, the information on managing the used model by the terminal equipment further includes:
that the model used by the terminal equipment is inapplicable to the configuration and/or the scenario, and the terminal equipment does not own and/or is unable to acquire a model applicable to the configuration and/or the scenario.

In at least one embodiment, the information on managing the used model by the terminal equipment further includes:
a message of successfully updating the model and information on the updated model.

In at least one embodiment, the information on managing the used model by the terminal equipment further includes:
a result of model management, or identification information (ID) corresponding to the result of model management, wherein, the result of model management includes: updating the model.

In at least one embodiment, the first transmitting unit is further configured to: transmit data for updating the model to the terminal equipment via signaling or in a form of data packet.

In at least one embodiment, the signaling includes: radio resource control (RRC), media access control control element (MAC CE) signaling or downlink control information (DCI).

In at least one embodiment, the updating the model includes: trimming or training the used model.

In at least one embodiment, the information on the updated model includes: identification information (ID) and/or model version information of the updated model.

In at least one embodiment, the data include original data and/or data obtained by quantifying the original data.

In at least one embodiment, the apparatus further includes:
a switching unit 1003 configured to switch a type of a model used by the network device for performing corresponding processing.

In at least one embodiment, the switching a type of the used model includes:
switching from an artificial intelligence model to a non-artificial intelligence model, or switching from a non-artificial intelligence model to an artificial intelligence model.

In at least one embodiment, the corresponding processing includes:
generating channel state information, and/or beam management, and/or positioning.

In at least one embodiment, the information on managing the used model by the terminal equipment includes:
switching the type of the used model for performing corresponding processing by the terminal equipment, and/or a time when switching takes effect, and/or a time interval between a time instant when the switching takes effect and a time instant when the reporting comes to an end, and/or a time interval between a time instant when the switching takes effect and a time instant when the reporting starts, and/or a type and/or a parameter of the used model after being switched.

In at least one embodiment, the information on managing the used model by the terminal equipment includes:
switching the used model to the updated model by the terminal equipment, and/or a time when switching takes effect, and/or a time interval between a time instant when the switching takes effect and a time instant when the network device receives the information on managing the used model by the terminal equipment.

In at least one embodiment, the switching unit 1003 is further configured to switch the model used by the network device to a model corresponding to the updated model.

### Embodiments of a Fifth Aspect

The embodiments of this disclosure provide a communication system, including a network device and a terminal equipment.

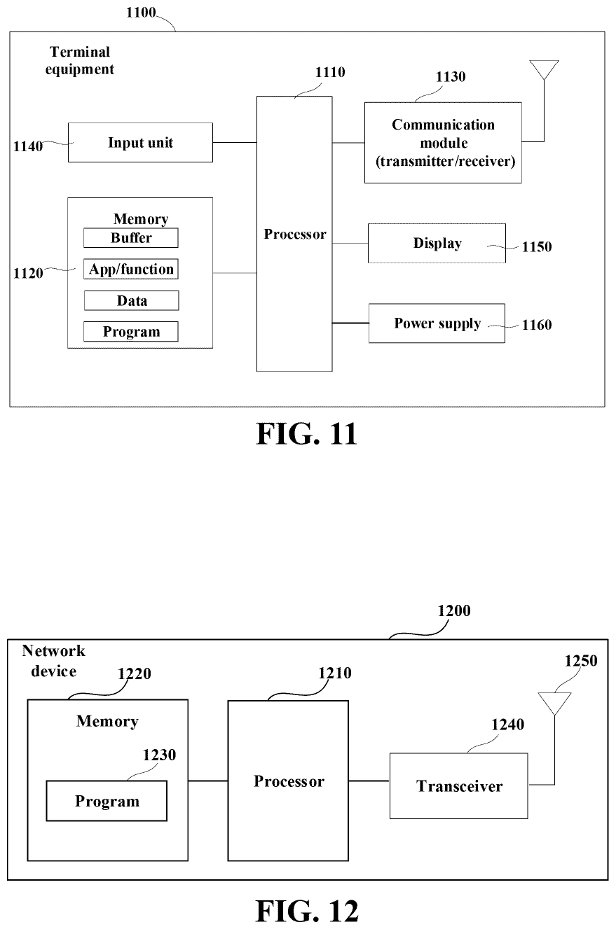

FIG. 11 is a schematic diagram of the terminal equipment of the embodiments of this disclosure. As shown in FIG. 11, the terminal equipment 1100 (such as corresponding to the terminal equipment 202 in FIG. 2) may include a processor 1110 and a memory 1120, the memory 1120 storing data and a program and being coupled to the processor 1110. It should be noted that this figure is illustrative only, and other types of structures may also be used, so as to supplement or replace this structure and achieve a telecommunications function or other functions.

In some embodiments, the processor 1110 may be configured to execute a program to carry out the method described in the embodiments of the first aspect.

As shown in FIG. 11, the terminal equipment 1100 may further include a communication module 1130, an input unit 1140, a display 1150, and a power supply 1160, wherein functions of the above components are similar to those in the related art, which shall not be described herein any further. It should be noted that the terminal equipment 1100 does not necessarily include all the parts shown in FIG. 11, and the above components are not necessary. Furthermore, the terminal equipment 1100 may include parts not shown in FIG. 11, and the related art may be referred to.

FIG. 12 is a schematic diagram of the network device of the embodiments of this disclosure. As shown in FIG. 12, the network device 1200 (such as corresponding to the network device 201 in FIG. 2) may include a processor 1210 (such as a central processing unit (CPU) and a memory 1220, the memory 1220 being coupled to the central processing unit 1210. Wherein, the memory 1220 may store various data, and furthermore, it may store a program 1230 for information processing, and execute the program under control of the central processing unit 1210.

For example, the central processing unit 1210 may be configured to execute a program to carry out the method described in the embodiments of the second aspect.

Furthermore, as shown in FIG. 12, the network device 1200 may include a transceiver 1240, and an antenna 1250, etc. Functions of the above components are similar to those in the related art, and shall not be described herein any further. It should be noted that the network device 1200 does not necessarily include all the parts shown in FIG. 12, and furthermore, the network device 1200 may include parts not shown in FIG. 12, and the related art may be referred to.

Embodiments of this disclosure provides a computer readable program, which, when executed in a terminal equipment, causes the terminal equipment to carry out the method as described in the embodiments of the first aspect.

Embodiments of this disclosure provides a computer storage medium, including a computer readable program, which causes a terminal equipment to carry out the method as described in the embodiments of the first aspect.

Embodiments of this disclosure provides a computer readable program, which, when executed in a network device, causes the network device to carry out the method as described in the embodiments of the second aspect.

Embodiments of this disclosure provides a computer storage medium, including a computer readable program, which causes a network device to carry out the method as described in the embodiments of the second aspect.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, an EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the spirits and principle of the present disclosure, and such variants and modifications fall within the scope of the present disclosure.

As to implementations containing the above embodiments, following supplements are further disclosed.

A method at a terminal side:

1. A method for model management, applicable to a terminal equipment, the method including:
receiving information on a configuration and/or a scenario transmitted by a network device; and
managing a model used by the terminal equipment according to the configuration and/or the scenario.

1a. The method according to supplement 1, wherein,
the model is used to generate channel state information (CSI), and/or beam management, and/or positioning.

1b. The method according to supplement 1, wherein,
the model is an artificial intelligence model,
the terminal equipment owns and/or is able to acquire at least one of the models,
and the model is applicable to at least one configuration and/or at least one scenario.

2. The method according to supplement 1, wherein,
the configuration includes an antenna configuration of the network device.

3. The method according to supplement 2, wherein,
the antenna configuration is used to configure at least one of the following parameters of an antenna of the network device:
the number of antenna panels included in a column of an antenna array;
the number of antenna panels included in a row of an antenna array;
a distance between antenna panels neighboring in a horizontal direction;
a distance between antenna panels neighboring in a vertical direction;
the antenna array being a uniform antenna array or a non-uniform antenna array; or
in an antenna panel, the number of antenna elements contained in a column, and/or the number of antenna elements contained in a row, and/or a distance between antennas neighboring in a horizontal direction, and/or a distance between antennas neighboring in a vertical direction, and/or an antenna in the antenna panel being of single polarization or dual polarization, and/or a tilt angle/tilt angles of a dual-polarized antenna/dual-polarized antennas.

4. The method according to supplement 2, wherein,
the number of the antenna configuration is one or more,
and more than one antenna configurations have corresponding antenna configuration identification numbers (IDs), or parameters of the antenna configurations and values corresponding to the antenna configurations are predefined.

5. The method according to supplement 1, wherein,
the method further includes:
receiving inquiry information transmitted by the network device, the inquiry information being used to inquire whether a model used and/or owned and/or able to be acquired by the terminal equipment is applicable to the configuration and/or the scenario.

5a. The method according to supplement 5, wherein,
the inquiry information includes the information on a configuration and/or a scenario, or the inquiry information does not include the information on a configuration and/or a scenario.

6. The method according to supplement 5, wherein,
the managing a model used by the terminal equipment includes:
verifying whether the model used and/or owned and/or able to be acquired by the terminal equipment is applicable to the configuration and/or the scenario; and
reporting that the model used by the terminal equipment is applicable to the configuration and/or the scenario to the network device as a result of model management, or reporting identification information (ID) corresponding to the result of model management to the network device.

7. The method according to supplement 5, wherein,
the managing a model used by the terminal equipment includes:
verifying whether the model used and/or owned and/or able to be acquired by the terminal equipment is applicable to the configuration and/or the scenario; and
reporting to the network device that the model used by the terminal equipment is inapplicable to the configuration and/or the scenario and the terminal equipment owns and/or is able to acquire a model applicable to the configuration and/or the scenario.

8. The method according to supplement 7, wherein,
the managing a model used by the terminal equipment further includes:
switching the model; and
reporting the following to the network device after switching the model:
a message of successful model switching, and/or information on a switched model, and/or a time when switching takes effect, and/or a time interval between a time instant when the switching takes effect and a time instant when the reporting comes to an end, and/or a time interval between a time instant when the switching takes effect and a time instant when the reporting starts.

8a. The method according to supplement 8, wherein,
the managing a model used by the terminal equipment further includes:
reporting switching the model to the network device as the result of model management, or reporting identification information (ID) corresponding to the result of model management to the network device.

8b. The method according to supplement 8, wherein,
the managing a model used by the terminal equipment further includes:
receiving a switching command transmitted by the network device, the switching command instructing the terminal equipment to switch the model.

9. The method according to supplement 8, wherein,
the information on the switched model corresponds to the configuration and/or the scenario.

10. The method according to supplement 5, wherein,
the managing a model used by the terminal equipment includes:
verifying whether the model used and/or owned and/or able to be acquired by the terminal equipment is applicable to the configuration and/or the scenario; and
reporting to the network device that the model used by the terminal equipment is inapplicable to the configuration and/or the scenario and the terminal equipment does not own and/or is unable to acquire a model applicable to the configuration and/or the scenario.

11. The method according to supplement 10, wherein,
the managing a model used by the terminal equipment further includes:
updating the model based on data received and/or downloaded from the network device; and
reporting a message of successfully updating the model and information on an updated model to the network device after updating the model.

11a. The method according to supplement 11, wherein,
the managing a model used by the terminal equipment further includes:
reporting updating the model to the network device as the result of model management, or reporting identification information (ID) corresponding to the result of model management to the network device.

11b. The method according to supplement 11, wherein,
the terminal equipment receives the data from the network device via signaling, or the terminal equipment receives the data from the network device in a form of data packet; or,
the terminal equipment downloads the data from a public server or a server with intellectual property (IP).

11b1. The method according to supplement 11b, wherein,
the signaling includes: radio resource control (RRC), media access control control element (MAC CE) signaling or downlink control information (DCI).

11c. The method according to supplement 11, wherein,
the updating the model includes: trimming or training the used model.

11d. The method according to supplement 11, wherein,
the information on the updated model includes: identification information (ID) and/or model version information of the updated model.

12. The method according to supplement 11, wherein,
the received data and/or the downloaded data include original data and/or data obtained by quantifying the original data.

13. The method according to supplement 11, wherein,
the managing a model used by the terminal equipment further includes:
switching a type of the used model for performing corresponding processing.

13a. The method according to supplement 13, wherein the switching a type of the used model includes:
switching from an artificial intelligence model to a non-artificial intelligence model, or switching from a non-artificial intelligence model to an artificial intelligence model.

13b. The method according to supplement 13, wherein,
the corresponding processing includes:
generating channel state information, and/or beam management, and/or positioning.

14. The method according to supplement 13, wherein,
the managing a model used by the terminal equipment further includes:
reporting the following to the network device before switching the type of the used model:
switching the type of the used model for performing corresponding processing by the terminal equipment, and/or a time when switching takes effect, and/or a time interval between a time instant when the switching takes effect and a time instant when the reporting comes to an end, and/or a time interval between a time instant when the switching takes effect and a time instant when the reporting starts, and/or a type and/or a parameter of the used model after being switched.

15. The method according to supplement 13, wherein,
the managing a model used by the terminal equipment further includes:
switching the used model to the updated model after updating the model, and reporting the following to the network device:
switching the used model to the updated model by the terminal equipment, and/or a time when switching takes effect, and/or a time interval between a time instant when the switching takes effect and a time instant when the reporting comes to an end, and/or a time interval between a time instant when the switching takes effect and a time instant when the reporting starts.

16. A method for performing antenna configuration, including:
defining a corresponding parameter name for a parameter of at least one antenna configuration.

A method at a network device side:

1. A model management method, applicable to a network device, the method including:
transmitting information on a configuration and/or a scenario to a terminal equipment; and
receiving information on managing a model used by the terminal equipment according to the configuration and/or the scenario by the terminal equipment.

1a. The method according to supplement 1, wherein,
the model is used to generate channel state information (CSI), and/or beam management, and/or positioning.

1b. The method according to supplement 1, wherein,
the model is an artificial intelligence model,
the terminal equipment owns and/or is able to acquire at least one of the models,
and the model is applicable to at least one configuration and/or at least one scenario.

2. The method according to supplement 1, wherein,
the configuration includes an antenna configuration of the network device.

3. The method according to supplement 2, wherein,
the antenna configuration is used to configure at least one of the following parameters of an antenna of the network device:
the number of antenna panels included in a column of an antenna array;
the number of antenna panels included in a row of an antenna array;
a distance between antenna panels neighboring in a horizontal direction;
a distance between antenna panels neighboring in a vertical direction;
the antenna array being a uniform antenna array or a non-uniform antenna array; or
in an antenna panel, the number of antenna elements contained in a column, and/or the number of antenna elements contained in a row, and/or a distance between antennas neighboring in a horizontal direction, and/or a distance between antennas neighboring in a vertical direction, and/or an antenna in the antenna panel being of single polarization or dual polarization, and/or a tilt angle/tilt angles of a dual-polarized antenna/dual-polarized antennas.

4. The method according to supplement 2, wherein,
the number of the antenna configuration is one or more,
and more than one antenna configurations have corresponding antenna configuration identification numbers (IDs), or parameters of the antenna configurations and values corresponding to the antenna configurations are predefined.

5. The method according to supplement 1, wherein,
the method further includes:
transmitting inquiry information to the terminal equipment, the inquiry information being used to inquire whether a model used and/or owned and/or able to be acquired by the terminal equipment is applicable to the configuration and/or the scenario.

5a. The method according to supplement 5, wherein,
the inquiry information includes the information on a configuration and/or a scenario, or the inquiry information does not include the information on a configuration and/or a scenario

6. The method according to supplement 5, wherein,
the information on managing the used model by the terminal equipment includes:
a result of model management, or identification information (ID) corresponding to the result of model management,
wherein the result of model management includes that the model used by the terminal equipment is applicable to the configuration and/or the scenario.

7. The method according to supplement 5, wherein,
the information on managing the used model by the terminal equipment includes:
that the model used by the terminal equipment is not applicable to the configuration and/or the scenario, and the terminal equipment owns and/or is able to acquire a model applicable to the configuration and/or the scenario.

8. The method according to supplement 7, wherein,
the information on managing the used model by the terminal equipment further includes:
a message of successful model switching, and/or information on a switched model, and/or a time when switching takes effect, and/or a time interval between a time instant when the switching takes effect and a time instant when the network device receives the information on managing the used model by the terminal equipment.

8a. The method according to supplement 8, wherein,
the information on managing the used model by the terminal equipment further includes:
a result of model management, or identification information (ID) corresponding to the result of model management,
wherein the result of model management includes: switching the model.

8b. The method according to supplement 8, wherein,
the method further includes:
transmitting a switching command to the terminal equipment, the switching command instructing the terminal equipment to switch the model.

9. The method according to supplement 8, wherein,
the information on the switched model corresponds to the configuration and/or the scenario.

10. The method according to supplement 5, wherein,
the information on managing the used model by the terminal equipment further includes:
that the model used by the terminal equipment is inapplicable to the configuration and/or the scenario, and the terminal equipment does not own and/or is unable to acquire a model applicable to the configuration and/or the scenario.

11. The method according to supplement 10, wherein,
the information on managing the used model by the terminal equipment further includes:
a message of successfully updating the model and information on the updated model.

11a. The method according to supplement 11, wherein,
the information on managing the used model by the terminal equipment further includes:
a result of model management, or identification information (ID) corresponding to the result of model management,
wherein the result of model management includes: updating the model.

11b. The method according to supplement 11, wherein,
the method further includes:
transmitting data for updating the model to the terminal equipment by the network device via signaling or in a form of data packet.

11b1. The method according to supplement 11b, wherein,
the signaling includes: radio resource control (RRC), media access control control element (MAC CE) signaling or downlink control information (DCI).

11c. The method according to supplement 11, wherein,
the updating the model includes: trimming or training the used model.

11d. The method according to supplement 11, wherein,
the information on the updated model includes: identification information (ID) and/or model version information of the updated model.

12. The method according to supplement 11b, wherein,
the data include original data and/or data obtained by quantifying the original data.

13. The method according to supplement 11, wherein,
the method further includes:
switching a type of the used model for performing corresponding processing.

13a. The method according to supplement 13, wherein the switching a type of the used model includes:
switching from an artificial intelligence model to a non-artificial intelligence model, or switching from a non-artificial intelligence model to an artificial intelligence model.

13b. The method according to supplement 13, wherein,
the corresponding processing includes:
generating channel state information, and/or beam management, and/or positioning.

14. The method according to supplement 13, wherein,
the information on managing the used model by the terminal equipment further includes:
switching the type of the used model for performing corresponding processing by the terminal equipment, and/or a time when switching takes effect, and/or a time interval between a time instant when the switching takes effect and a time instant when the reporting comes to an end, and/or a time interval between a time instant when the switching takes effect and a time instant when the reporting starts, and/or a type and/or a parameter of the used model after being switched.

15. The method according to supplement 13, wherein,
the information on managing the used model by the terminal equipment further includes:
switching the used model to the updated model by the terminal equipment, and/or a time when switching takes effect, and/or a time interval between a time instant when the switching takes effect and a time instant when the network device receives the information on managing the used model by the terminal equipment.

16. The method according to supplement 15, wherein,
the method further includes:
switching the used model by the network device to a model corresponding to the updated model.

What is claimed is:

1. An apparatus for model management, applicable to a terminal equipment, the apparatus comprising:
a first receiver configured to receive information on a configuration and/or a scenario transmitted by a network device; and
managing processor circuitry configured to manage a model used by the terminal equipment according to the configuration and/or the scenario.

2. The apparatus according to claim 1, wherein,
the model is used to generate channel state information (CSI), and/or beam management, and/or positioning.

3. The apparatus according to claim 1, wherein,
the model is an artificial intelligence model,
the terminal equipment owns and/or is able to acquire at least one of the models, and the model is applicable to at least one configuration and/or at least one scenario.

4. The apparatus according to claim 1, wherein,
the configuration comprises an antenna configuration of the network device.

5. The apparatus according to claim 2, wherein,
the antenna configuration is used to configure at least one of the following parameters of an antenna of the network device:
the number of antenna panels comprised in a column of an antenna array;
the number of antenna panels comprised in a row of an antenna array;
a distance between antenna panels neighboring in a horizontal direction;
a distance between antenna panels neighboring in a vertical direction;
the antenna array being a uniform antenna array or a non-uniform antenna array; or
in an antenna panel, the number of antenna elements contained in a column, and/or the number of antenna elements contained in a row, and/or a distance between antennas neighboring in a horizontal direction, and/or a distance between antennas neighboring in a vertical direction, and/or an antenna in the antenna panel being of single polarization or dual polarization, and/or a tilt angle/tilt angles of a dual-polarized antenna/dual-polarized antennas.

6. The apparatus according to claim 4, wherein,
the number of the antenna configuration is one or more,
and more than one antenna configurations have corresponding antenna configuration identification numbers (IDs), or parameters of the antenna configurations and values corresponding to the antenna configurations are predefined.

7. The apparatus according to claim 1, wherein,
the first receiver is further configured to:
receive inquiry information transmitted by the network device, the inquiry information being used to inquire whether a model used and/or owned and/or able to be acquired by the terminal equipment is applicable to the configuration and/or the scenario.

8. The apparatus according to claim 7, wherein,
the inquiry information comprises the information on a configuration and/or scenario, or the inquiry information does not comprise the information on a configuration and/or scenario.

9. The apparatus according to claim 7, wherein,
the to manage the model used by the terminal equipment comprises:
verifying whether the model used and/or owned and/or able to be acquired by the terminal equipment is applicable to the configuration and/or the scenario; and
reporting to the network device that the model used by the terminal equipment is applicable to the configuration and/or the scenario to the network device as a result of model management, or reporting identification information (ID) corresponding to a result of model management.

10. The apparatus according to claim 7, wherein,
the to manage the model used by the terminal equipment comprises:
verifying whether the model used and/or owned and/or able to be acquired by the terminal equipment is applicable to the configuration and/or the scenario; and
reporting to the network device that the model used by the terminal equipment is inapplicable to the configuration and/or the scenario and the terminal equipment owns and/or is able to acquire a model applicable to the configuration and/or the scenario.

11. The apparatus according to claim 7, wherein,
the to manage the model used by the terminal equipment further comprises:
verifying whether the model used and/or owned and/or able to be acquired by the terminal equipment is applicable to the configuration and/or the scenario; and
reporting to the network device that the model used by the terminal equipment is inapplicable to the configuration and/or the scenario and the terminal equipment does not own and/or is unable to acquire a model applicable to the configuration and/or the scenario.

12. An apparatus for model management, applicable to a network device, the apparatus comprising:
a first transmitter configured to transmit information on a configuration and/or a scenario to a terminal equipment; and
a second receiver configured to receive information on managing a model used by the terminal equipment according to the configuration and/or the scenario by the terminal equipment.

13. The apparatus according to claim 12, wherein,
the model is used to generate channel state information (CSI), and/or beam management, and/or positioning.

14. The apparatus according to claim 12, wherein,
the model is an artificial intelligence model,
the terminal equipment owns and/or is able to acquire at least one of the models,
and the model is applicable to at least one configuration and/or at least one scenario.

15. The apparatus according to claim 12, wherein,
the configuration comprises an antenna configuration of the network device.

16. The apparatus according to claim 12, wherein,
the first transmitter is further configured to:
transmit inquiry information to the terminal equipment, the inquiry information being used to inquire whether a model used and/or owned and/or able to be acquired by the terminal equipment is applicable to the configuration and/or the scenario.

17. The apparatus according to claim 16, wherein,
the inquiry information comprises the information on a configuration and/or a scenario, or the inquiry information does not comprise the information on a configuration and/or a scenario.

18. The apparatus according to claim 16, wherein,
the information on managing the used model by the terminal equipment comprises:
a result of model management, or identification information (ID) corresponding to the result of model management,
wherein the result of model management comprises that the model used by the terminal equipment is applicable to the configuration and/or the scenario.

19. The apparatus according to claim 16, wherein,
the information on managing the used model by the terminal equipment comprises:
that the model used by the terminal equipment is inapplicable to the configuration and/or the scenario, and the terminal equipment owns and/or is able to acquire a model applicable to the configuration and/or the scenario.

20. The apparatus according to claim 16, wherein,
the information on managing the used model by the terminal equipment further comprises:
that the model used by the terminal equipment is inapplicable to the configuration and/or the scenario, and the terminal equipment does not own and/or is unable to acquire a model applicable to the configuration and/or the scenario.
